(19) United States
(12) Patent Application Publication
(10) Pub. No.: US 2017/0361553 A1
(43) Pub. Date: Dec. 21, 2017

(54) SIPE BLADE VENTING STRUCTURE

(71) Applicant: Bridgestone Americas Tire Operations, LLC, Nashville, TN (US)

(72) Inventor: Edward S. SEROKA, Akron, OH (US)

(73) Assignee: Bridgestone Americas Tire Operations ,LLC, Nashville, TN (US)

(21) Appl. No.: 15/540,123

(22) PCT Filed: Nov. 17, 2015
(86) PCT No.: PCT/US2015/061062

§ 371 Date: Jun. 27, 2017

Related U.S. Application Data
(60) Provisional application No. 62/098,439, filed on Dec. 31, 2014.

(51) Int. Cl. B29D 30/06

(52) U.S. Cl. CPC B29D 30/0606; B29D 2030/0613; B29D 2030/0617

(57) ABSTRACT

A system for venting a tire mold including at least one conduit that creates a fluid connection between an interior and an exterior of a tire mold, with at least one sipe blade extending across the conduit such that the air to either side of the sipe blade will exit the tire mold interior when a tire is formed.

### FIELD OF THE INVENTION

The present disclosure relates to venting structures for tire molds. More particularly, the present disclosure relates to a venting structure for a sipe blade region of a tire mold.

### BACKGROUND

Tire molds include vent structures that allow the air in a tire mold to be displaced when rubber is compressed or injected into the mold. Sipe blades are sometimes included in a tire mold to create patterns in the finished tire. When the rubber is injected into the mold, the rubber will form around a sipe blade to create a void in the cured tire matching the shape of the sipe in a finished tire. In prior art structures, sipe blades include holes within the blade to allow air to vent from one side of the sipe blade to the other. The size of the holes, the number of the holes and the location of the holes is an exacting process and due to sipe size, material constraints and sipe placement during mold preparation, can be limiting. This results in less than optimal air flow. These structures degrade the appearance of a finished tire, as sprues may form on either side of the sipe blade, and break when the tire is removed from the mold. This can also result in tire “lightness,” where rubber does not completely fill in the voids of the tire mold and sipe junctions.

### SUMMARY

In one embodiment, a tire mold has an interior surface and an exterior surface with a conduit connecting the two surfaces in a fluid connection. This embodiment further includes at least one sipe blade extending across an interior opening of the conduit, into an interior of the tire mold. This embodiment further includes a vent insert located within the at least one conduit.

In another embodiment, a system for venting a tire mold includes a tire mold with interior and exterior regions in fluid connection with each other via at least one conduit extending from the exterior region to the interior region. This embodiment further includes at least one sipe blade located in the interior region of the tire mold, that extends across the at least one conduit.

In another embodiment, a tire mold has an interior region and an exterior region with a conduit connecting the two in a fluid connection. This embodiment further includes at least one sipe blade positioned at an interior opening of the conduit, and extending into the interior region of the tire mold. The sipe blade in this embodiment is embedded into the tire mold. This embodiment further includes a vent insert located within the at least one conduit, and positioned between the sipe blade and the exterior region of the tire mold.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a front view of one embodiment of a notched sipe blade and a vent insert in a tire mold shown in cross section;

FIG. 2 is a front view of an exemplary vent insert in a tire mold shown in cross section;

FIG. 3 is a front view of an alternative embodiment of a sipe blade and a notched vent insert in a tire mold shown in cross section;

FIG. 4 is a side view of an exemplary notched vent insert;

FIG. 5 is a front view of another alternative embodiment of a notched sipe blade in a notched vent insert in a tire mold shown in cross section;

FIG. 6A is a top view of one embodiment of a sipe blade bisecting a single conduit; and

FIG. 6B is a top view of an alternative embodiment of a sipe blade with three segments and two conduits for venting.

### DETAILED DESCRIPTION

The following includes definitions of selected terms employed herein. The definitions include various examples or forms of components that fall within the scope of a term and that may be used for implementation. The examples are not intended to be limiting. Both singular and plural forms of terms may be within the definitions.

Directions are stated herein with reference to the tire mold. For example “interior,” “inside,” or “inner” refers to a direction or area towards the center cavity of a tire mold. The terms “exterior,” “outside,” or “outer” refer to a direction or area generally outside of the tire mold.

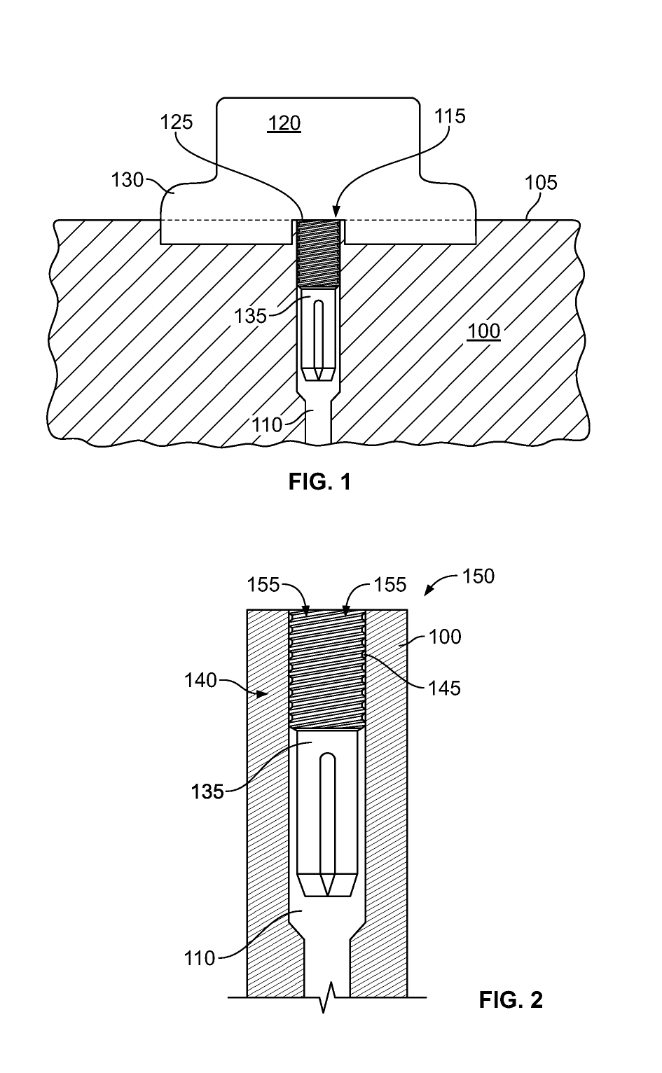

FIG. 1 illustrates a cross-section view of a first embodiment of the sipe venting structure. A tire mold 100 includes an interior surface 105 for receiving material used in manufacturing tires. The interior surface 105 may take any shape suitable for forming tires. The tire mold 100 further comprises a conduit 110 for venting air from the interior of the tire mold 100 to an exterior (not shown) of the tire mold 100. The conduit 110 may take any form, but here is depicted as a cylindrical through hole, with an opening 115 in the interior surface 105. The opening 115 permits fluid communication between the interior of the tire mold 100 and the exterior of the tire mold 100 via the conduit 110. Other venting structures known in the art may be used without departing from the scope of the present disclosure.

A sipe blade 120 is secured in an opening in the tire mold 100, such that a bottom of the sipe blade 120 is embedded within the tire mold 100. Any means of securing the sipe blade 120 to the tire mold 100 may be used without departing from the scope of the present disclosure, including but not limited to forming the tire mold with the sipe blade, permanently mounting sipe blade after forming the tire mold, or affixing sipe blade to tire mold in a removable manner.

In this embodiment, the sipe blade 120 is depicted as having a flat rectangular top, having side portions 130 being shorter than the flat rectangular top, extending further than the flat rectangular top in a lengthwise direction, and having rounded outer portions. A bottom edge of the sipe blade 120 is substantially straight, with a notch 125 located in a central region of the bottom edge. The notch 125 is sized such that it is coextensive with the opening 115 in the interior surface 105. Other shapes are possible for the sipe blade 120, and may be substituted without departing from the scope of the present disclosure.

In this embodiment, the notch 125 is located near the center of the sipe blade 120, and the sipe blade 120 is positioned so as to bisect the conduit 110 over a diameter of the conduit 110. In an alternative embodiment, the notch is off-centered. In other alternative embodiments, sipe blade may not bisect the conduit.

FIG. 1 also shows a schematic of a generally cylindrical vent insert 135, located within the conduit 110. The top of vent insert 135 is positioned parallel to the interior surface 105 and to the notch 125. The notch 125 is dimensioned to receive the vent insert 135. The vent insert 135 can be mounted into the conduit 110 using any means known to one of ordinary skill in the art. The notch 125 may vary in depth, but in this embodiment, notch 125 has a depth matching the ‘sipe embedment depth’ of the sipe into the mold. The ‘sipe embedment depth’ (the depth to which the sipe blade 120 is embedded into the tire mold 100) is a design depth established by a designer, taking into account constraints of the particular application. The ‘sipe embedment depth’ in this embodiment ranges from 0.15 inches to 0.25 inches, but this range may be increased based on constraints of the application.

FIG. 2 illustrates a front view of an exemplary vent insert in a tire mold shown in cross section. It should be understood that the illustrated insert is merely exemplary and that any vent insert may be employed. The vent insert 135 includes a threaded portion 140 having a plurality of spiral channels 145. Spiral channels 145 are formed in the threaded portion 140 and run continuously from a top 150 of the vent insert 135 and along a portion of a length of the vent insert 135. Each spiral channel 145 defines an intake opening 155 located at the top 150 of the vent insert 135. In other embodiments, the spiral channels may be replaced with straight channels. Any number of channels may be employed. Additionally, other types of vent inserts may be used without departing from the scope of the present disclosure, including but not limited to spring vents, drill vents, micro vents, or sinter vents.

With continued reference to FIG. 2, the vent insert 135 in this embodiment is a sprueless type vent insert. The exemplary vent insert 135 allows gas from the interior of the tire mold 100 to vent to an exterior of tire mold 100, reducing or preventing the formation of tire sprues. When tire material is compressed or injected into the tire mold 100, the air inside the tire mold 100 is displaced. The displaced air is forced into the intake openings 155, through the channels 145, out the threaded portion 140 and finally through the rest of conduit 110 until reaching an exterior of the tire mold 100. The shape and size of the intake openings 155 prevent sprues from forming when tire material comes into contact with the interior surface 105 and the threaded portion top 150. A designer can optimize the airflow through the channels 145 on each side of the vent by varying the size, geometry, location, or number of channels.

The threaded portion 140 in this exemplary vent insert 135 has an outer diameter approximately equivalent to an inner diameter of the conduit 110 and diameter of the opening 115. In this embodiment, an equal number of intake openings 155 are located on either side of the sipe blade 120 when installed. However, other arrangements of the intake openings 155 may be used without departing from the scope of the present disclosure. For example an unequal number of vent intakes 155 may be located to either side of the sipe blade 120. In alternative embodiments, a different type of vent insert may be used, or the vent insert may be omitted altogether. The diameter of the vent insert 135 can be optimized to accommodate the width of the sipe blade and the available mold surface area available.

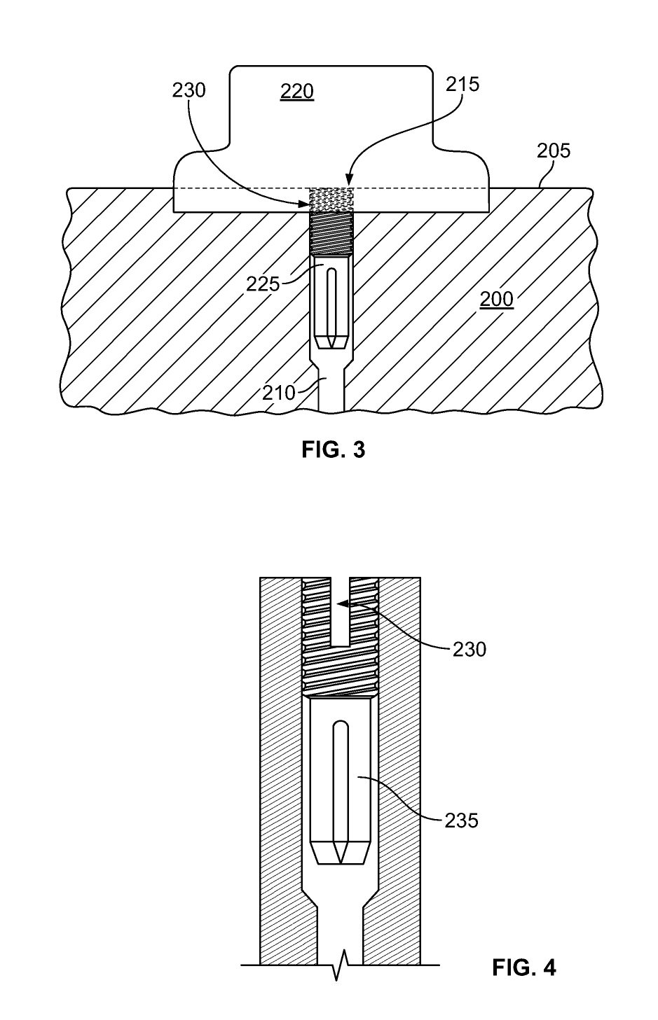

FIG. 3 depicts a front view of an alternative embodiment of a sipe blade and a notched vent insert in a tire mold shown in cross section. In this embodiment, a tire mold 200 has an interior surface 205 and a conduit 210. The conduit 210 includes an opening 215 that permits fluid communication between the interior of the tire mold 100 and an exterior (not shown) of the tire mold 100. A vent insert 225 is located within the conduit 210. The vent insert 225 is positioned so that a top portion is flush with the interior surface 205. As in other embodiments, other types of vent inserts or other arrangements of vent inserts may be used without departing from the scope of the present disclosure.

In the embodiment shown in FIG. 3, the bottom edge of the sipe blade 220 does not include a notch. Rather, the bottom edge of the sipe blade 220 is straight, and located outside of the interior surface 205. The vent insert 225 includes a vent insert notch 230 in a top portion thereof, which receives the sipe blade 220. The vent insert notch 230 is positioned in a central diameter of the vent insert 225. In this embodiment, the sipe blade 220 passes through the conduit opening 215, and through the vent insert 225 via the vent insert notch 230. The vent insert notch 230 has a width approximately equal to the thickness of the sipe blade 220, to form a tight connection between the vent insert 225 and the sipe blade 220. Alternatively, the vent insert notch may have a width greater than the blade thickness. Vent insert notch 230 may vary in depth, but in this embodiment, vent insert notch 230 has a depth matching the ‘sipe embedment depth’ of the sipe into the mold. The ‘sipe embedment depth’ (the depth to which the sipe blade 220 is embedded into the tire mold 200) is a design depth established by a designer, taking into account constraints of the particular application. The ‘sipe embedment depth’ in this embodiment ranges from 0.15 inches to 0.25 inches, but this range may be increased based on constraints of the application.

In an alternative embodiment (not shown), the vent insert notch may be located off-center of the vent insert, so that it is not positioned along a diameter of the vent insert. In such an embodiment, the sipe blade would not pass through a diameter of the conduit opening, and instead would pass through a distance less than the diameter of the conduit.

FIG. 4 illustrates a side view of the exemplary vent insert 225 of the FIG. 3 embodiment. The vent insert 225 is substantially the same as the vent insert 150 of FIGS. 1 and 2, except for the addition of the notch 230 in a top portion of the vent insert 225 for receiving the sipe blade 220. It should be understood that the illustrated insert is merely exemplary and that any vent insert may be employed. As in other embodiments, other types of vent inserts or other arrangements of vent inserts may be used without departing from the scope of the present disclosure.

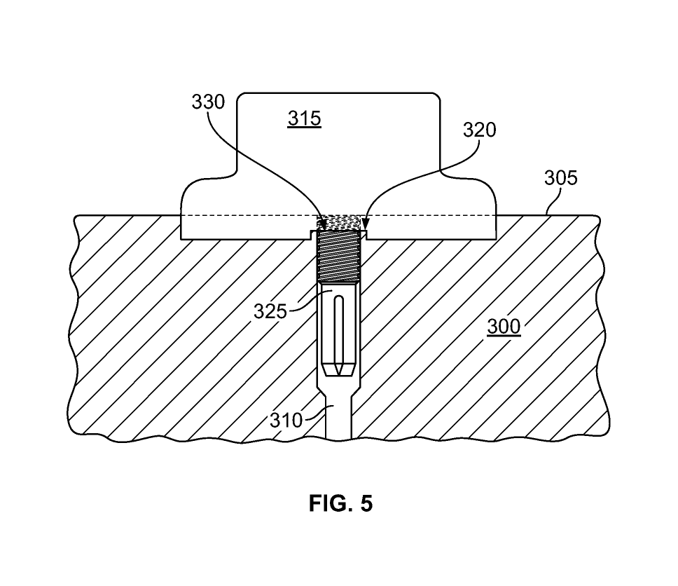

FIG. 5 illustrates another alternative embodiment of a sipe vent structure in a tire mold shown in cross section. In this embodiment, a tire mold 300 comprises an interior surface 305 and a conduit 310. The conduit 310 permits fluid communication between an interior of the tire mold 300 and an exterior (not shown) of the tire mold 300. A vent insert 325 is located in conduit 310.

A bottom edge of the sipe blade 315 includes a notch 320. The notch 320 is dimensioned to the receive vent insert 325. A top of the notch 320 is located outside of the interior surface 305. Additionally, the vent insert 325 includes a vent notch 330 located on a top portion thereon, and aligned with the notch 320 of the sipe blade 315. In this embodiment, the vent notch 330 is the same width as the sipe blade 315. The bottom of the vent notch 330 is adjacent to a top of the notch 320 such that the vent notch 330 and the notch 320 form an interlocking engagement. In an alternative embodiment (not shown) a gap may be formed between the bottom of the vent notch 330 and the top of notch 320 of the sipe blade 315. In another alternative embodiment, the vent insert notch 330 may have a width greater than the sipe blade thickness.

In yet another alternative embodiment (not shown), the vent insert notch may be located off-center of the vent insert, so that it is not positioned along a diameter of the vent insert. In such an embodiment, the sipe blade would not pass through a diameter of the conduit opening, and instead would pass through a distance less than the diameter of the conduit.

In the embodiment of FIG. 5, a top of the vent insert 325 is flush with the interior surface 305. Other arrangements are possible without departing from the scope of the present disclosure. The notch 320 and the vent notch 330 may vary in depth, but in this embodiment meet at a depth slightly less than the ‘sipe embedment depth’ of the sipe into the mold. The ‘sipe embedment depth’ (the depth to which the bottom most edge of sipe blade 315 is embedded into the tire mold 300) is a design depth established by a designer, taking into account constraints of the particular application. The ‘sipe embedment depth’ in this embodiment ranges from 0.15 inches to 0.25 inches, but this range may be increased based on constraints of the application.

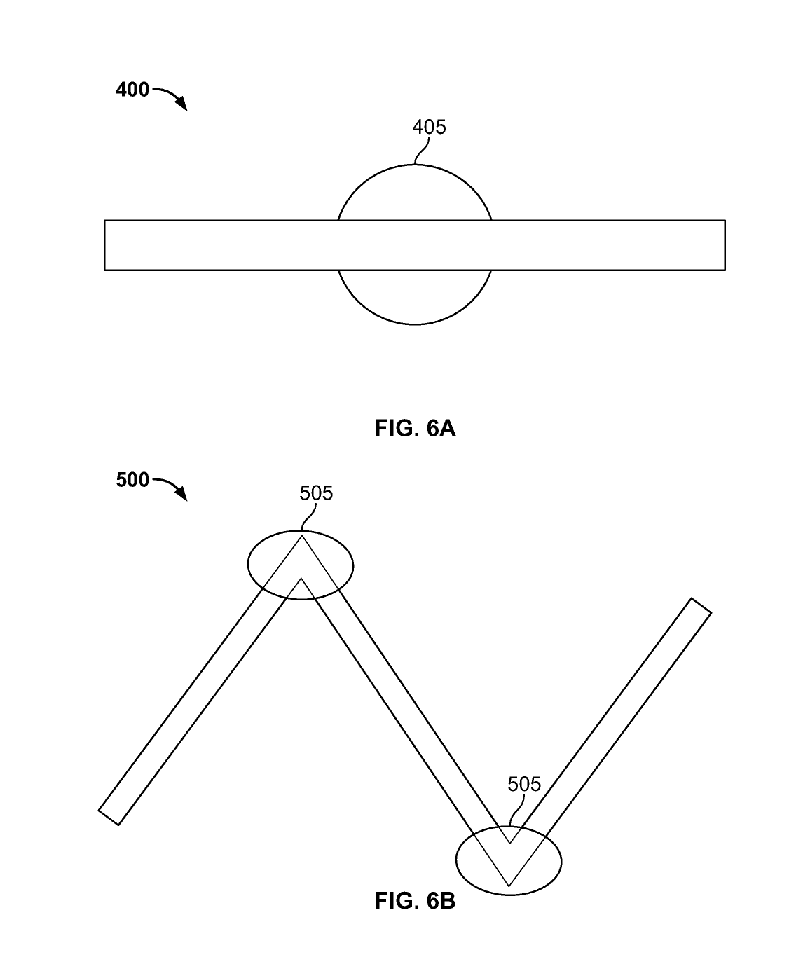

FIG. 6a depicts a top-down view of one possible arrangement of a sipe blade 400 and a vent structure 405. In this arrangement, sipe blade 400 bisects venting structure 405. This arrangement can be used for any of the embodiments disclosed herein.

FIG. 6b illustrates an alternative arrangement of the sipe blade 500. The sipe blade 500 in this embodiment is segmented into three parts, each angled with respect to the adjacent segment. In this embodiment, any number of sipe blade segments may be used, and the sipe blades may be arranged to form any angles with respect to each other. Alternatively, three separate sipe blades may be arranged in this manner. This type of arrangement may be used with any of the above described embodiments of the sipe venting structure. One or more venting structures 505 may be located beneath the sipe blade 500. The venting structures 505 may be any of the above described embodiments, and may include vent inserts, conduits, vents inserts with notches, etc. as described above. The sipe blade may also be a single curve, multiple curves, or a serpentine shape incorporating different radii.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A tire mold comprising:
a tire mold interior surface;
at least one conduit extending from the tire mold interior surface to an exterior of the tire mold, wherein the at least one conduit includes at least one conduit opening at the tire mold interior surface;
at least one sipe blade disposed in the tire mold interior surface, wherein the sipe blade extends across the at least one conduit opening; and
at least one vent insert, and
wherein at least a portion of the at least one vent insert is located inside of the at least one conduit.

2. The tire mold of claim 1, wherein a top surface of the at least one vent insert is adjacent to the at least one sipe blade, and the top surface of the at least one vent insert includes a vent notch configured to receive the at least one sipe blade.

3. The tire mold of claim 1, wherein the at least one conduit is a plurality of conduits each having a conduit opening, and the at least one sipe blade is a plurality of sipe blades, wherein each of the of sipe blades extends across one of the conduit openings.

4. The tire mold of claim 1, wherein the at least one vent insert has an even number of vent insert channels extending along a side surface of the vent insert, and wherein each vent insert channel has an intake opening at a vent insert top surface.

5. The tire mold of claim 1, wherein the at least one sipe blade further includes a sipe blade notch that is aligned with the opening of the at least one conduit.

6. The tire mold of claim 1, wherein the at least one sipe blade includes a sipe blade notch that is wider than a diameter of the at least one conduit.

7. The tire mold of claim 1, wherein the at least one vent insert includes a top surface that is flush with the tire mold interior surface.

8. A system for venting a tire mold, comprising:
a tire mold having an interior region and an exterior region,
wherein the interior and exterior regions of the tire mold are in fluid connection with each other via at least one conduit extending from the exterior region to the interior region; and
at least one sipe blade located in the interior region of the tire mold, extending across the at least one conduit.

9. The system of claim 8, further including at least one vent insert, wherein at least a portion of the at least one vent insert is located inside the at least one conduit, and at least a portion of the vent insert is located between the sipe blade and the exterior region.

10. The system of claim 9, wherein a top surface of the vent insert is adjacent to the sipe blade, and wherein a vent insert front surface includes a vent insert notch that receives the sipe blade.

11. The system of claim 10, wherein the vent insert front surface is flush with an interior surface of the interior region of the tire mold.

12. The system of claim 8, wherein the at least one sipe blade bisects the at least one conduit opening along a diameter of the at least one conduit opening.

13. The system of claim 9, wherein the at least one vent insert has an even number of channels extending along a side surface of the vent insert,
wherein each channel has an intake opening at a top surface of the vent insert, and
wherein an equal number of intake openings are located to either side of the sipe blade.

14. The system of claim 9, wherein the at least one sipe blade includes a sipe blade notch that receives a vent top surface of the vent insert.

15. The system of claim 9, wherein the at least one sipe blade includes a sipe blade notch, wherein the at least one vent insert includes a vent insert notch, and wherein the sipe blade notch and vent insert notch are configured to interlock with each other.

16. A tire mold comprising:
an interior region;
an exterior region,
wherein the interior and exterior regions of the tire mold are connected via at least one conduit extending from the exterior region to the interior region, and
wherein the interior region is defined by an interior surface;
at least one sipe blade embedded in the tire mold and extending from the interior surface into the tire mold interior region, wherein the sipe blade is positioned at an interior opening of the conduit;
at least one vent insert, wherein at least a portion of the vent insert is located within the at least one conduit, and at least a portion of the vent insert is located between the sipe blade and the exterior region.

17. The tire mold of claim 16, wherein the at least one vent insert includes a vent insert top surface adjacent to the sipe blade, wherein the vent insert top surface includes a vent notch, and wherein the vent notch is configured to receive the at least one sipe blade.

18. The tire mold of claim 16, wherein the at least one sipe blade includes a sipe blade notch that is configured to receive the vent insert.

19. The tire mold of claim 16, wherein the vent insert has an even number of vent insert channels extending along a side surface of the vent insert.

20. The tire mold of claim 19, wherein at least a portion of the at least one vent insert is located within the conduit,
wherein each vent insert channel has an intake opening on a top surface of the vent insert, and
wherein half of the vent insert channel intake openings are located on one side of the sipe blade.
